(19) United States
(12) Patent Application Publication
(10) Pub. No.: US 2008/0170233 A1
(43) Pub. Date: Jul. 17, 2008

(54) Apparatus for compatible glass substrate test disk for component level measurement of a head gimbal assembly

(76) Inventor: Dongman Kim, Campbell, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/654,899

(22) Filed: Jan. 17, 2007

(51) Int. Cl. G01B 9/02

(52) U.S. Cl. 356/507

(57) ABSTRACT

An optical test stand using a first glass substrate compatible with the glass substrate of a disk for a hard disk drive. A first method uses an optical test stand to perform both intensity-based and phase-based interferometry to create improved estimates of the flying height of a slider off of rotating disk surface, and the flying height estimate as a product of that process. Optical test stand may further include a first light source only in the blue spectrum and/or a light source actuator for positioning the first light source.

### TECHNICAL FIELD

This relates to an optical test stand for component level measurement of the flying height capability of a head gimbal assembly, in particular to using a first glass substrate compatible with a hard disk drive's disks to improve light based measurements for estimating the flying height capability of the head gimbal assembly before assembly in the hard disk drive.

### BACKGROUND

The hard disk drive of today is rapidly evolving. The flying height of the slider above the disk surface has shrunk below ten nanometers, the threshold of nanotechnology. This progress has put significant strains on many aspects of the hard disk drive industry. Today, an optical technique is widely used to assess the flying height, or air gap, as it sometimes called. The previously prevailing intensity-based interferometry approaches have been found to have several weaknesses, even after compensating by using three distinct wavelengths, most of which are outside the blue to ultra-violet color spectrum, thus of longer wavelength.

Intensity-based interferometry is tending to be replaced by phase-based interferometry because it can provide higher sensitivity in such near-contact regimes. However, it is very expensive and requires extensive modification to both the measurement system hardware and the software used by such systems. What is needed is a method of accurately measuring parameters of a head gimbal assembly on a test stand without all of the expense of phase-based interferometry.

What is further needed is a test stand supporting measuring the effects of a slider flying over a surface comparable to a production disk surface in a fully assembled hard disk drive. Today this cannot be done except in a hard disk drive, which is a very expensive and restrictive environment for testing.

### SUMMARY

This application will first discuss three embodiments of an optical test stand, followed by two methods preferably using these embodiments:
The first embodiment uses a test disk including a first glass substrate compatible with a second glass substrate used in the disks of a hard disk drive, which is often a 2½ inch hard disk drive.
The second embodiment further uses a first light source having each of its one or more output bands in the blue to ultra-violet color spectrum.
The third embodiment further uses a light source actuator positioning the first light source at a light source position to support creating a three-dimensional map of the air bearing surface of the slider being tested.
The first method is a flying height estimate method that creates an intensity estimate and a phase estimate by operating the optical test stand, which are used with an intensity curve and a phase curve to create the flying height estimate. The optical test stand preferably includes at least the first embodiment.
The second method operates an optical test stand similar to the third embodiment, controlling the light source actuator and using the first method to provide the flying height estimate to create a three-dimensional map of the slider.
This second method can be used to create a touch-down estimate and/or a take-off estimate for a slider. As used herein, the touch-down estimate is an estimate the rotational rate for the test disk at which the air bearing of the slider collapses, and the slider touches down on the rotating disk surface. Also, the take-off estimate is an estimate of the rotational rate at which the air bearing forms and becomes stable, which is when the slider takes off from the rotating disk surface. Both of these estimate rely altering the rotational rate and then creating the three-dimensional map of the air bearing surface, because what portion of the slider is first or last to contact the disk surface varies.
By extending the optical test stand to control environmental conditions such as temperature, humidity and air pressure, the methods of this application can be employed to test the environmental effects of the performance of the slider in its head gimbal assembly. In particular, it is possible to measure the effect of high temperature and humidity, which often leads to condensation across the air bearing and a drop in the flying height of the slider. Also, the effect of changing air pressure on the flying height of the slider can be estimated.

A first embodiment of the optical test stand, includes a spin table include a first glass substrate coated with a protective layer topped by a layer of lubricant providing a rotating disk surface near which the air bearing surface of a slider is positioned by an actuator assembly. The first glass substrate is compatible with the second glass substrate used in a disk of a hard disk drive, which will be further discussed in the following detailed description. The spin table is illuminated by a optical interferometer measuring an interference between a first light path and a second light path, both from a first light source. The first light path includes a reflection off a test disk surface opposite the rotating disk surface. And the second light path includes a reflection off the air bearing surface of the slider near the rotating disk surface.

The first glass substrate may provide the rotating disk surface with a first micro-waviness and the second glass substrate may provide a second rotating disk surface with a second micro-waviness, where the second rotating disk surface is included in the disk in the hard disk drive. The first micro-waviness may preferably be within N percent of the second micro-waviness. Where N is at most twenty and N may further preferably be at most ten.

A second embodiment of the optical test stand, includes a first light source emitting at least one output band only in the blue to ultra-violet color spectrum. The first light source originates a first light path and a second light path used by an optical interferometer to measure the interference between the first light path and the second light path. The first light path includes a reflection off a test disk surface. And the second light path includes a reflection off the air bearing surface of a slider near a rotating disk surface opposite the test disk surface.

The output band may be composed of a monochromatic light output component or a polychromatic light component, both included in the blue to ultra-violet color spectrum. The first light source may preferably be a short wavelength coherent light source, preferably a laser, and even more preferably a laser diode. The first light source may provide at least two wavelengths. The first light source may further emit at least two output bands in the blue to ultra-violet color spectrum.

The emitted light of the first light source may preferably be in the blue to ultra-violet wavelength. As used herein, the blue to ultra-violet color spectrum may further include all electromagnetic radiation with a wavelength between 449 nanometers and 501 nanometers.

A third embodiment of the optical test stand, includes an optical interferometer using a first light source positioned by a light source actuator to originate a first light path and a second light path. The first light path includes a reflection off a test disk surface. And the second light path includes a reflection off the air bearing surface of a slider near a rotating disk surface opposite the test disk surface.

The light source actuator may preferably position the first light source with at least one degree of motion-freedom. The motion of the first light source as positioned by the light source actuator may preferably be non-parallel to the motion of the air bearing surface of the slider as positioned by the actuator assembly. Further preferred, these motions may be approximately perpendicular. The motion of the first light source as positioned by the light source actuator in conjunction with the motion of the air bearing surface of the slider as positioned by the actuator assembly may preferably support three dimensional contour mapping of the air bearing surface. The three dimensional contour mapping of the air bearing surface may preferably include an estimate of the crown and of the camber of the slider.

In certain embodiments, the slider may include a vertical micro-actuator stimulated by a vertical actuation control signal. The three dimensional contour mapping of the air bearing surface may preferably include an estimate of a change in flying height of the read-write head of the slider when the vertical actuation control signal stimulates the vertical micro-actuator.

The first optical interferometer further operates and is methodically used as follows:
The light output of the first light source is presented to a splitter generating the first light path between the slider and a test disk surface, and a second light path of essentially the same distance as the first light path, by which it is meant that the two light paths are nearly the same length, and when optically combined, an interference B3 is created which is used by the interferometric receiver IR.
Both the first and second light paths end at an interferometric detector, which measures both the intensity and phase map of these two light paths and the reflections from the first light path are measured by an interferometric receiver and analyzed by a detector.
These measurements create an intensity curve and a phase curve. These two curves show distinct sensitivities, with the phase curve having improved sensitivity where the intensity curve has constant slope and vice versa.

Embodiments may implement a first method using the optical test stand to estimate flying height of the slider from the rotating disk surface. The flying height estimate is a product of the first method.

Embodiments may include a processor controlling the optical test stand to at least partly implement the first method. The processor creates the estimate of the flying height based upon the intensity estimate and the phase estimate and often reports the flying height estimate. The processor may preferably include at least one instance of a controller. As used herein, each controller receives at least one input, maintains and updates at least one state and generates at least one output based upon at least one of the inputs and/or at least one of the states. As used herein, a controller may include an instance of a finite state machine, and/or include an instance of an inference engine and/or an instance of a neural network and/or an instance of a computer directed by a program system including program steps or operations residing in a memory accessibly coupled to the computer. As used herein, a computer includes at least one instruction processor and at least one data processor, where each of the data processors is directed by at least one of the instruction processors.

A second method may operate the optical test stand of the third embodiment to create a three-dimensional map of the air bearing surface of the slider by further controlling the optical test stand and using the first method to create a flying height estimate. The second method may further derive an estimate of the camber and/or the crown of the slider and/or the vertical actuated deformation of the slider when it includes a vertical micro-actuator.

### BRIEF DESCRIPTION OF THE DRAWINGS

FIG. 1A shows an example of the first embodiment of an optical test stand using the first glass substrate in the test disk, where the first glass substrate is compatible with a second glass substrate used in a disk in a hard disk drive, preferably a 2.5 inch hard disk drive;

FIG. 1B shows a detail of FIG. 1A further showing the first micro-waviness of the first glass substrate which is compatible with the second micro-waviness of the second glass substrate;

FIG. 2A shows a second embodiment of the optical test stand of FIG. 1A where the light beam includes at least one output band in the blue to ultra-violet color spectrum as shown through various examples of FIGS. 2B to 2E;

FIG. 3A shows a third embodiment of the optical test stand including a light source actuator for position the first light source;

FIGS. 3B to 3D show various examples of the motion of the light source of FIG. 3A;

FIG. 3E shows an example of a three-dimensional map of the air bearing surface created using the third embodiment of the optical test stand;

FIGS. 3F and 3G show the crown of the slider;

FIG. 3H shows the camber of the slider;

FIGS. 3J and 3K show an example of a vertical actuated deformation of the slider and the flying height change resulting from activating a vertical micro-actuator included in the slider;

FIGS. 4A and 4B show elements of the optical test stand in terms of an interferometric receiver and an interferometric detector communicating via an interferometric communicative coupling;

FIG. 5A shows an example of an intensity curve used with various embodiments and methods;

FIG. 5B shows an example of a phase curve used with various embodiments and methods;

FIGS. 6 and 7 show a control system including a processor operating the optical test stand to implement a first method creating a flying height estimate;

FIG. 8A shows the processor including at least one instance of a controller;

FIG. 8B shows the controller receiving at least one input, maintaining and updating the value of at least one state and generating at least one output based upon at least one of the inputs and/or the value of at least one of the states;

FIGS. 8C and 8D show some details of the values of a state of a controller;

FIG. 8E shows an instance of a controller including a finite state machine;

FIG. 8F shows an instance of a controller including an inference engine;

FIG. 8G shows an instance of a controller including a neural network;

FIG. 9A shows the processor of FIGS. 6, 7 and 8A including an instance of the controller, including a computer accessibly coupled via a buss to a memory and at least partly directed by a program system to support the first method creating the flying height estimate;

FIG. 9B shows one member of the means group of FIG. 7 including a finite state machine;

FIG. 9C shows one member of the means group of FIG. 7 including an inference engine;

FIG. 9D shows member one of the means group of FIG. 7 including a neural network;

FIG. 9E shows member one of the means group of FIG. 7 including a computer;

FIG. 10 shows an example of the second method using the first method as shown in FIGS. 7 and 9A with the third embodiment of the optical test stand of FIG. 3A.

### DETAILED DESCRIPTION

This relates an optical test stand for component level measurement of the flying height capability of a head gimbal assembly, in particular to the using a first glass substrate compatible with a hard disk drive in the optical test stand to improve light based measurements for estimating the flying height capability of the head gimbal assembly before assembly in the hard disk drive.

This application will first discuss three embodiments of an optical test stand 200, followed by two methods preferably using these embodiments:
The first embodiment uses a test disk 12T including a first glass substrate GS-1 compatible 8 with a second glass substrate GS-2 using in the disk 12 of a hard disk drive 10, which is often a 2.5 inch hard disk drive.
The second embodiment further uses a first light source LS1 having each of its one or more output bands OB in the blue to ultra-violet color spectrum BCS.
The third embodiment further uses a light source actuator LSA positioning the first light source LS1 at a light source position LSP to support creating a three-dimensional map 92C of the air bearing surface 92 of the slider 90 being tested.
The first method 320 creates an intensity estimate 154 and a phase estimate 156 by operating the optical test stand, which are used with the intensity curve 802 and the phase curve 804 to create the flying height estimate 158. The optical test stand preferably includes at least the first embodiment and/or the second embodiment.
The second method 330 operates an optical test stand similar to the third embodiment, controlling the light source actuator and using the first method to provide the flying height estimate to create a three-dimensional map 92C of the slider.

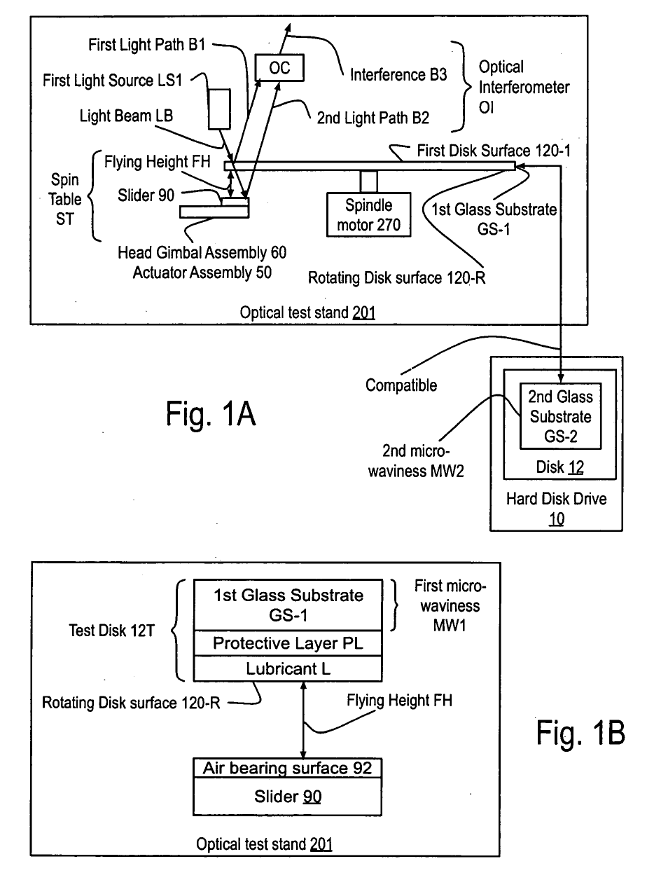

The first embodiment of the optical test stand 200 as shown in FIGS. 1A and 1B, include a spin table ST may preferably include a first glass substrate GS-1 coated with a protective layer PL topped by a layer of lubricant L providing a rotating disk surface 120 near which the air bearing surface 92 of a slider is positioned by an actuator assembly 50, which preferably couples to the slider through a head gimbal assembly 60. In further detail:
The first glass substrate is compatible 8 with a second glass substrate GS-2 used in a disk 12 of a two and one half inch hard disk drive 10.
The spin table ST is illuminated by a optical interferometer OI measuring an interference B3 between a first light path B1 and a second light path B2, both from a first light source LS1.

The first light path B1 includes a reflection off a test disk surface 120-1 opposite the rotating disk surface 120-R.

And the second light path B2 includes a reflection off the air bearing surface 92 of the slider 90 near the rotating disk surface 120-R.

The test disk 12T may be manufactured by providing the compatible 8 first glass substrate GS-1. The protective layer PL is deposited on the first glass substrate by sputtering carbon for form a protective, diamond like carbon layer, which is the same protective layer created on the disk 12 in the hard disk drive 10. The test disk is then lubricated with, preferably, same lubricant L as is used for the disk in the hard disk drive.

The first glass substrate GS-1 may provide the rotating disk surface 120-R with a first micro-waviness MW1 and the second glass substrate GS-2 may provide a second rotating disk surface of the disk 12 with a second micro-waviness MW2, where the second rotating disk surface is included in the disk in the hard disk drive 10, preferably a 2.5 inch hard disk drive. The first micro-waviness MW1 may preferably be within N percent of the second micro-waviness MW2. Where N is at most twenty and N may further preferably be at most ten.

As used herein micro-waviness MW and waviness are often measured in terms of the angstroms at several output band OB. In the following table, micro-meters will be represented by μm, nanometers by nm, and angstroms by A. The table summarizes some of these compatible measurements:

TABLE ONE
showing a test disk 12T with a first glass substrate GS-1 compatible 8 with
two examples of a hard disk drive 10.

| | | | | First hard disk | | Second hard disk | |
|---|---|---|---|---|---|---|---|
| | | Test disk 12-T | | drive 10 | | drive 10 | |
| | | First disk | Rotating disk | Disk 12 | 2^{nd} disk | Disk 12 | 2^{nd} disk |
| | Wavelength | surface | surface | first disk | first disk | first disk | first disk |
| Parameter | Range | 120-1 | 120-R | surface | surface | surface | surface |
| Micro- | 200–1500 μm | 2.79 A | 2.52 A | 3.66 A | 3.60 A | 3.23 A | 2.64 A |
| waviness | | | | | | | |
| Waviness | 400–5000 μm | 0.602 nm | 0.586 nm | 0.391 nm | 0.385 nm | 0.468 nm | 0.460 nm |

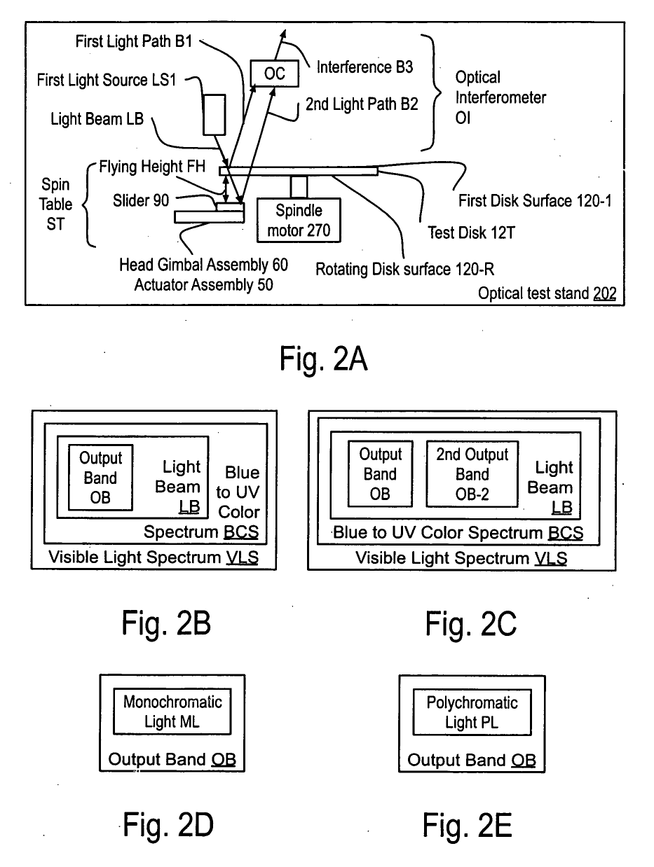

The second embodiment of the optical test stand 200 as shown in FIG. 2A, includes the first light source LS1 emitting at least one output band OB only in the blue to ultra-violet color spectrum BCS, as shown in FIGS. 2B. In further detail, the first light source originates the first light path B1 and the second light path B2 used by the optical interferometer OI to measure the interference B3 between the first light path and the second light path. The first light path includes a reflection off a test disk surface 120-1. And the second light path includes a reflection off the air bearing surface 92 of the slider 90 near the rotating disk surface 120-R opposite the test disk surface.

The output band OB may be composed of a monochromatic light component ML or a polychromatic light component PL, both included in the blue to ultra-violet color spectrum BCS, as shown in FIGS. 2D and 2E. The first light source LS1 may preferably be a short wavelength coherent light source, preferably a laser, and even more preferably a laser diode. The first light source may provide at least two wavelengths, in certain embodiments as two output bands as shown in FIG. 2C, each including monochromatic light, and in other embodiments as a single output band including polychromatic light. The first light source may further emit the at least two output bands in the blue to ultra-violet color spectrum.

The emitted light of the first light source LS1 may preferably be in the blue to ultra-violet wavelength, which will be referred to herein as the blue to ultra-violet color spectrum BCS. As used herein, the blue to ultra-violet color spectrum may further include all electromagnetic radiation with a wavelength between 449 nanometers and 501 nanometers. As used herein, the blue to ultra-violet color spectrum is considered a subset of the visible light spectrum VLS.

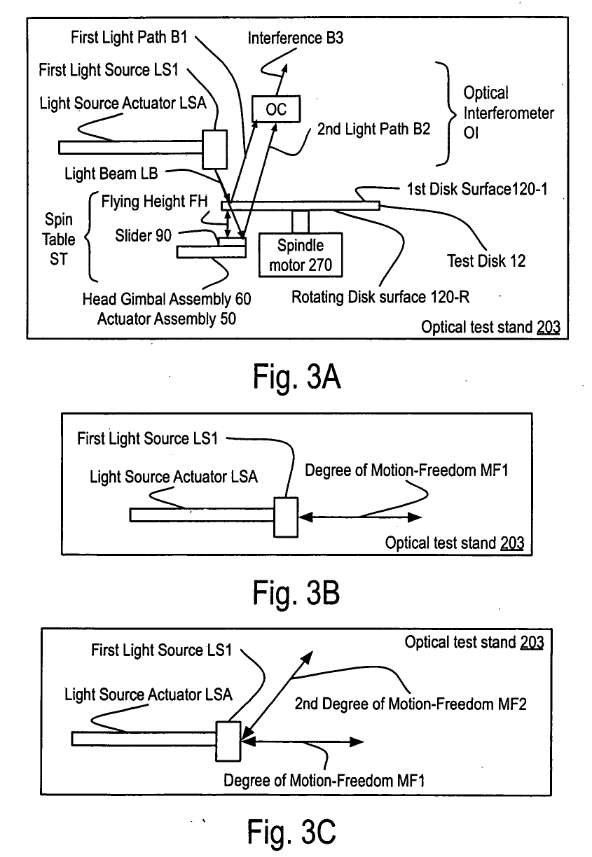

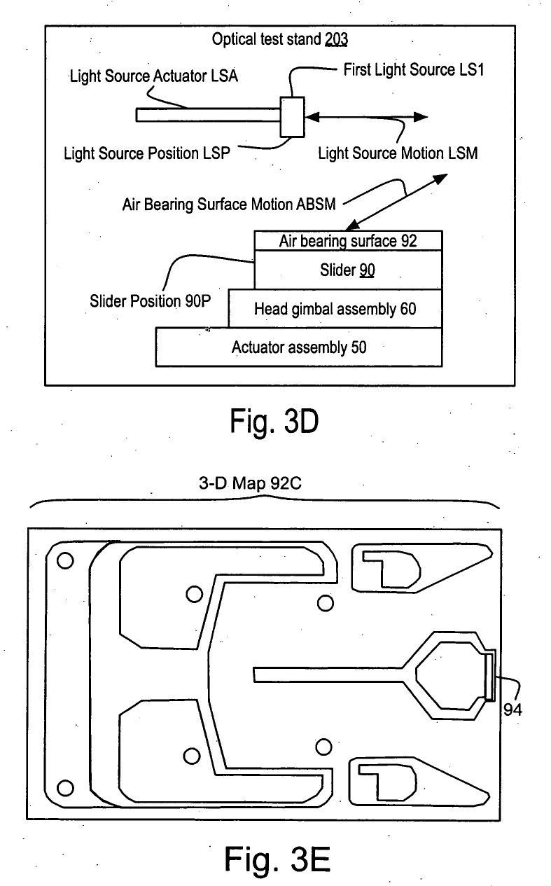

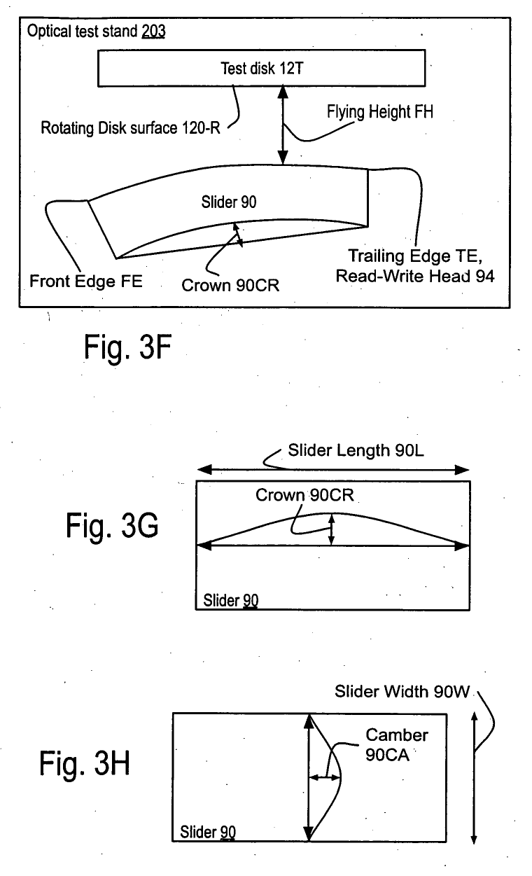

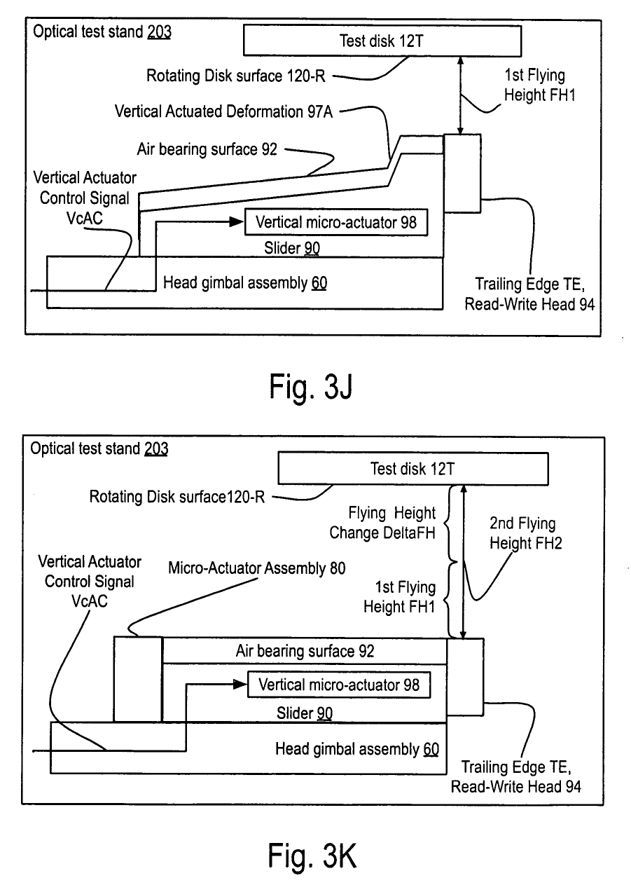

The third embodiment may preferably includes the optical test stand 200 as shown in FIGS. 3A to 3K, further comprising: The optical interferometer OI using a first light source LS1 positioned by a light source actuator LSA to originate the first light path B1 and the second light path B2. The first light path includes the reflection off the test disk surface 120-1. And the second light path includes the reflection off the air bearing surface 92 of the slider 90 near a rotating disk surface 120-R opposite the test disk surface.

The light source actuator LSA may preferably position the first light source LS1 with at least one degree of motion-freedom. The light source actuator may position the first light source with exactly one degree of motion-freedom MF1, as shown in FIG. 3B. Alternatively, the light source actuator may position the first light source with two or more degrees of motion-freedom as shown in FIG. 3C with a second degree of motion-freedom MF2.

The motion of the first light source LS1 as positioned by the light source actuator LSA may preferably be non-parallel to the motion of the air bearing surface 92, referred to herein as the air bearing surface motion ABSM, of the slider 90 as positioned by the actuator assembly 50 and the head gimbal assembly 60, as shown in FIG. 3D. Further preferred, these motions may be approximately perpendicular.

The motion of the first light source LS1, referred to herein as the light source motion LSM, is positioned by the light source actuator LSA in conjunction with the motion of the air bearing surface, referred to herein as the air bearing surface motion ABSM, of the slider 90 as positioned by the actuator assembly 50 may preferably support three dimensional contour mapping of the air bearing surface 92, which creates a 3-D contour 92C as shown in FIG. 3E. In further detail, the three dimensional contour mapping of the air bearing surface 92 may preferably provide an estimate of the crown 90CR as shown in FIGS. 3F and 3G and an estimate of the camber 90CA as shown in FIG. 3H, both of which are often associated with the slider 90. Put another way, the crown 90CR refers herein to a measure of the bending of the slider 90 along the slider length 90L, and the camber 90CA refers to a measure of the bending of the slider along the slider width 90W. Measurements may also be made of the twist of the slider, which is usually denoted as the bending of the slider between its opposite corners. By way of example, the optical test stand 200 may be used with a pico slider 90, which is often considered to have a slider length of 1.235 millimeters (mm) and a slider width of 1.00 mm. Another example, the optical test stand may be used with a pemto slider, which is often considered to have a slider length of 1.235 millimeters (mm) and a slider width of 0.70 mm. Another example, the optical test stand may be used with a femto slider, often considered to have a slider length of 0.85 mm and a slider width of 0.70 mm.

The optical test stand 200 may further include a second optical interferometer with a second light source to further refine the slider position.

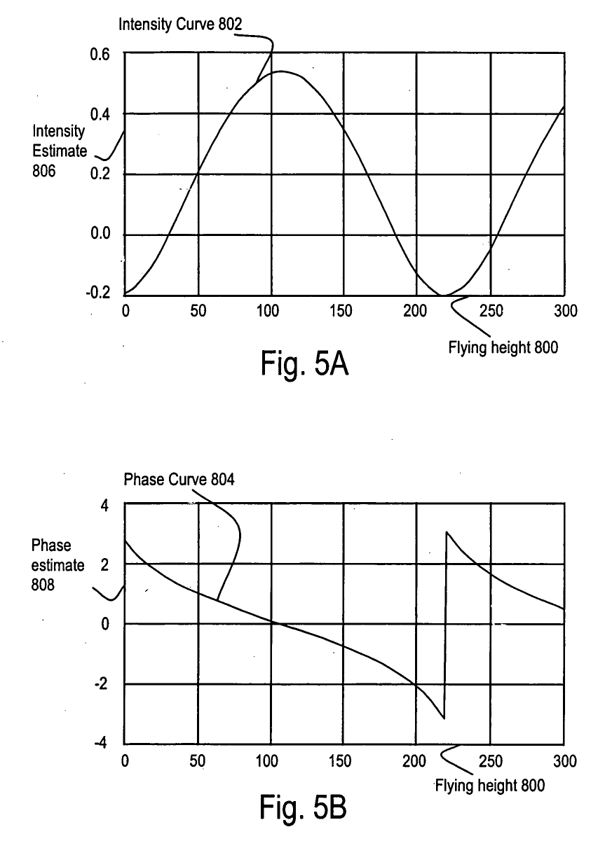

In certain embodiments, the slider 90 may include a vertical micro-actuator 98 stimulated by a vertical actuator control signal VcAC. The three dimensional contour mapping of the air bearing surface may preferably include an estimate of a change in flying height FH, which will be referred to as the flying height change DeltaFH of the read-write head 94 of the slider 90 when the vertical actuation control signal stimulates the vertical micro-actuator as shown in FIGS. 3J and 3K. In further detail, these Figures show an example of the slider including a vertical micro-actuator using a thermal-mechanical effect, where the effect of stimulating the vertical actuator control signal VcAC causes the vertical micro-actuator 98 to heat a region of the slider as shown in FIG. 3J, thereby causing the first flying height FH1 to be closer to the rotating disk surface 120-R of the test disk 12T, than the second flying height FH2, as shown in FIG. 3K. In this example, the flying height change DeltaFH is the difference between two flying heights, in this example, between the second flying height FH2 and the first flying height FH1. Alternatively the flying height change DeltaFH may be difference between the first flying height FH1 and the second flying height FH2. Other embodiments of the vertical micro-actuator 98 may use a piezoelectric effect and/or an electrostatic effect to alter the flying height FH, but in general, they will operate very similarly to the example shown in FIGS. 3J and 3K, the primary point of variation may be whether FIG. 5A represents the stimulated or the unstimulated result of the vertical micro-actuator.

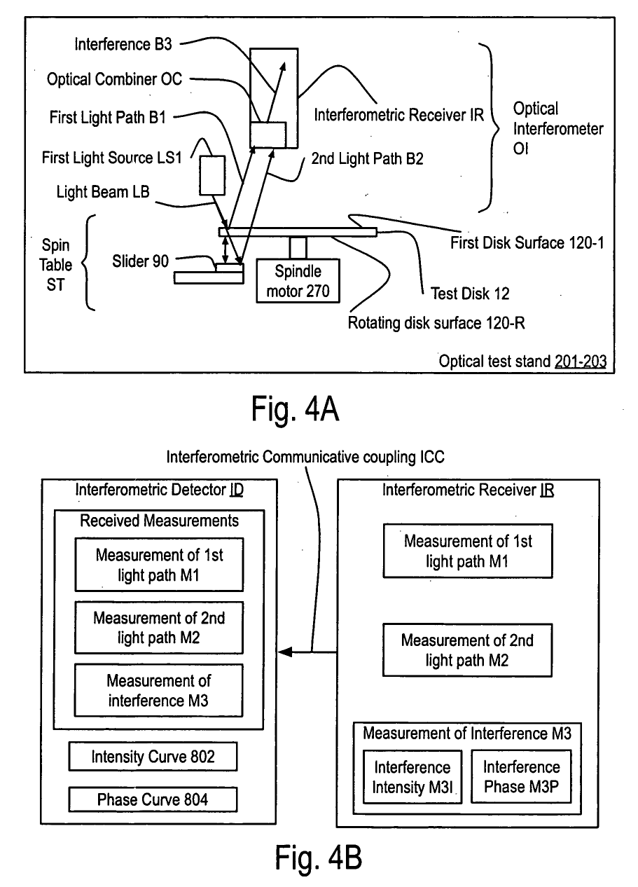

The first optical interferometer OI as shown in FIGS. 4A and 4B further operates and is methodically used as follows: The light output of the first light source LS1 is presented to a splitter generating the first light path B1 between the slider 90 and the test disk surface 120-1, and the second light path B2 of essentially the same distance as the first light path. Both the first light path B1 and the second light path B2 may preferably end at an interferometric receiver IR, which may preferably measures both the intensity and phase of these two light paths as shown in FIG. 4A. These measurements are sent by the interferometric receiver to be analyzed by an interferometric detector ID as shown in FIG. 4B.

These measurements are used by the interferometric detector to create an intensity curve 802 shown in some detail in FIG. 5A and a phase curve 804 shown in some detail in FIG. 5B. These two curves show distinct sensitivities, with the intensity curve having improved sensitivity where the phase curve has constant slope and vice versa. The horizontal axis 800 of both Figures represents the flying height FH of the slider 90 over the rotating disk surface 120-R in units of nanometers. The vertical axis 808 of FIG. 5B preferably represents radian units of a phase estimate 158. The vertical axis 806 of FIG. 5A represents an intensity estimate 156, which will shortly be described in further detail.

One way to understand the relationship between flying height FH and the intensity estimate 154 is to consider the following theoretical example, which is based upon the thin film equation. Assuming the following notation:
h represents the flying height FH of the slider.
λ represents the wavelength of the light beam LB,
n₀ represents the refractive index of air.
(n₁+ik₁)represents the refractive index of the slider 90.
(n₂+ik₂)represents the refractive index of the first glass substrate GS-1.
r₂₀ represents the reflection coefficient of the glass-air boundary.
r₀₁ represents the reflection coefficient of the air-slider boundary.
I₀ represents intensity of the light incident to the slider-disk interface, which is also known herein as the first light path B1.
I_{S} represents intensity of the light reflected from the slider-disk interface, which is also known herein as the second light path B2.

The reflected intensity I_{S} is related to the previous items by the following formulas:

$$\begin{matrix}{I}_{S} = {I}_{0} \frac{{r}_{20}^{2} + {\vert {r}_{01} \vert}^{2} + 2 {r}_{20} \vert {r}_{01} \vert cos ( δ + {φ}_{S} )}{1 + {r}_{20}^{2} {\vert {r}_{01} \vert}^{2} + 2 {r}_{20} \vert {r}_{01} \vert cos ( δ + {φ}_{S} )} & ( 1.1 ) \\ δ = 4 π h / λ & ( 1.2 ) \\ {φ}_{S} = π - {tan}^{- 1} ( \frac{2 {n}_{0} {k}_{1}}{{n}_{0}^{2} - {n}_{1}^{2} - {k}_{1}^{2}} ) & ( 1.3 ) \\ {r}_{20} = \frac{( {n}_{2} + {ik}_{2} ) - {n}_{0}}{( {n}_{2} + {ik}_{2} ) + {n}_{0}} & ( 1.4 ) \\ {r}_{01} = \frac{{n}_{0} - ( {n}_{1} + {ik}_{1} )}{{n}_{0} + ( {n}_{1} + {ik}_{1} )} & ( 1.5 )\end{matrix}$$

These formulas illustrate the relationship shown in the intensity curve 802 of FIG. 5A.

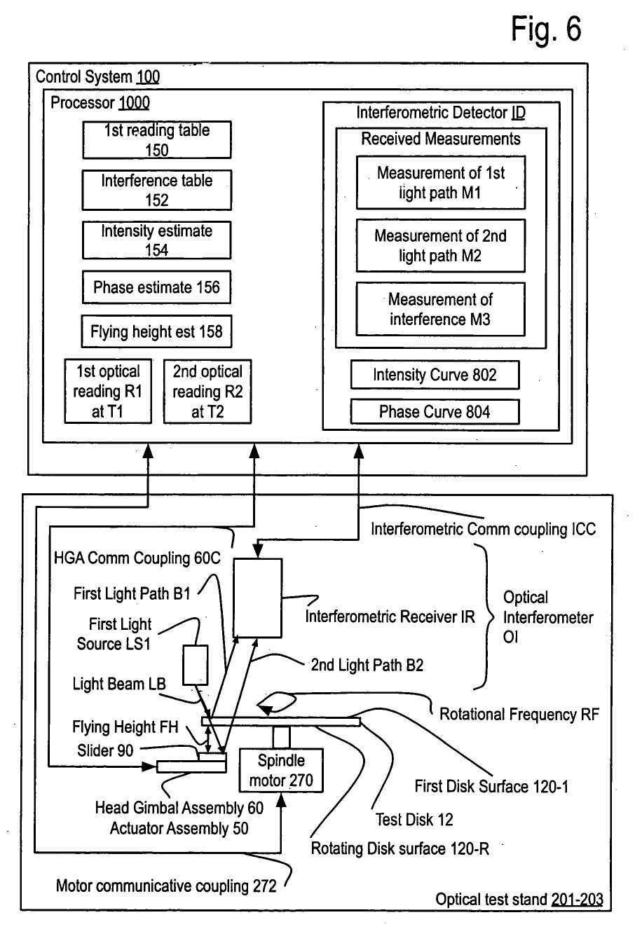

The interferometric detector ID may further operate within a control system 100 for an optical test stand as shown in FIG. 6:
A processor 1000 may embody the interferometer detector ID of FIG. 4B interacting through an interferometric communications coupling ICC with the interferometric receiver IR.
The processor may also preferably control the spindle motor 270 through a motor communicative coupling 272.
The processor may also preferably control the positioning of the slider 90 through a head gimbal assembly communicative coupling 60C to the actuator assembly 50 and further to the head gimbal assembly 60, which includes the slider.

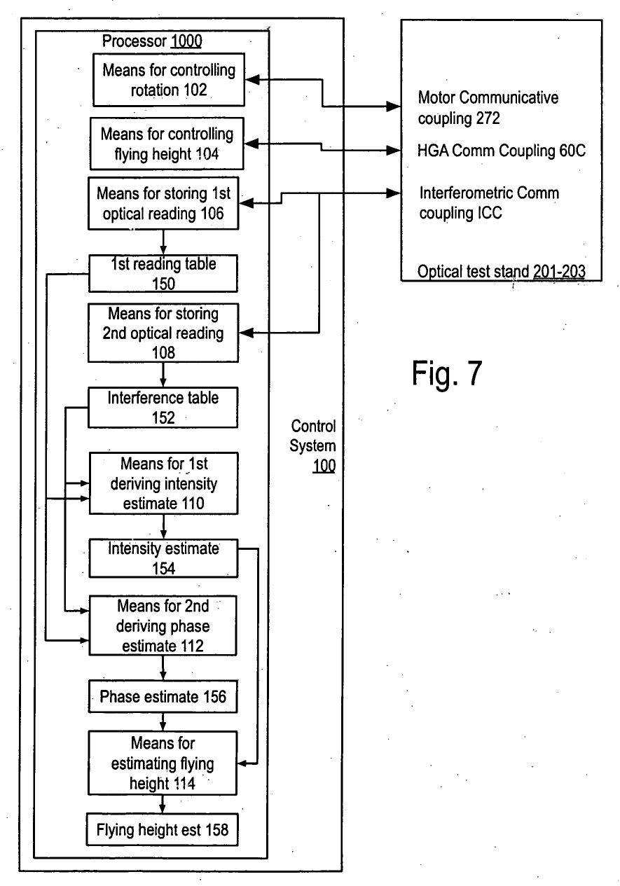

Embodiments may implement the first method using the optical test stand 200 to estimate flying height FH of the slider 90 from the rotating disk surface 120-R, are shown through example in FIGS. 6 and 7, performing the following operations:
Controlling rotation 102 of a test disk 12T to create the rotating disk surface 120-R at a rotational frequency RF.
Controlling flying height 104 of a slider 90 above the rotating disk surface, where the slider is coupled to and controlled through a head gimbal assembly 60, preferably using a head gimbal assembly communicative coupling 60C.
Powering a first light source LS1 to provide a first light beam LB of at least one wavelength to the test disk 12T to create a first optical response B1 and to the slider 90 to create a second optical response B2.
Measuring the first optical response B1 to create a first optical reading R1 at a first reading time T1.
Optically combining OC the first optical response and the second optical response B2 to create an interference response B3.
Measuring the interference response to create a second optical reading R2 at a second reading time T2.
First storing 106 the first optical reading in a first reading table 150 based upon the first reading time.
Second storing 108 the second optical reading in an interference table 152 based upon the second reading time.
First deriving 110 an intensity estimate 154 based upon the first reading table, the interference table and the rotational frequency.
Second deriving 112 a phase estimate 156 based upon the first reading table, the interference table, and the rotational frequency.
And estimating based upon the intensity estimate and the phase estimate to create an estimate of the flying height FH as the flying height estimate 158. The flying height estimate is a product of this method.
The flying height estimate is a product of this first method.

The processor 1000 may preferably control the optical test stand 200 to at least partly implement the first method as follows:
The processor controls the rotation 102 of the test disk 12T to create the rotating disk surface 120-R at the rotational frequency RF through the motor communicative coupling 272.
The processor controls the flying height 104 the slider 90 above the rotating disk surface head gimbal assembly communicative coupling 60C provided to the head gimbal assembly 60. The control being provided is altered by the aerodynamic forces generated by the interaction of air flow between the rotating disk surface 120-R and the air bearing surface 92 as well as the mechanical response of the actuator assembly 50 and the head gimbal assembly 60, all of which ultimately affect the flying height FH of the slider, particularly at its trailing edge TE, which is often the part of the slider which will be closest to the disk in a hard disk drive 10.
The processor receives a measurement of the first optical response B1 to create the first optical reading R1 at the first reading time T1.
The processor measures the interference response B3 to create the second optical reading R2 at the second reading time T2.
The processor stores the first optical reading in the first reading table 150 based upon the first reading time.
The processor stores the second optical reading in the interference table 152 based upon the second reading time.
The processor derives the intensity estimate 154 based upon the first reading table, the interference table and the rotational frequency RF of the test disk 12T with its test disk surface 120-2 and its rotating disk surface 120-R.
The processor derives the phase estimate 156 based upon the first reading table, the interference table, and the rotational frequency.
And the processor creates the estimate of the flying height, referred to herein a flying height estimate 158 based upon the intensity estimate and the phase estimate. The processor typically reports the flying height estimate as part of a manufacturing process evaluating the head gimbal assembly 60 and/or the slider 90.

The intensity estimate 156 may preferably approximate the ratio of the intensity the second optical reading R2 to the first optical reading R1. The first optical reading is measured from the first optical response B1 of the first light beam and the glass disk 12. The second optical reading is measured from the interference response B3, which results from optically combining OC the first optical response B1 and the second optical response B2. The second optical response results from the first light beam interacting with the slider 90 at its flying height FH above the rotating disk surface 120.

Measuring the first optical response B1 and measuring the interference response B3 may occur concurrently in some embodiments, whereas in others, they may be measured sequentially.

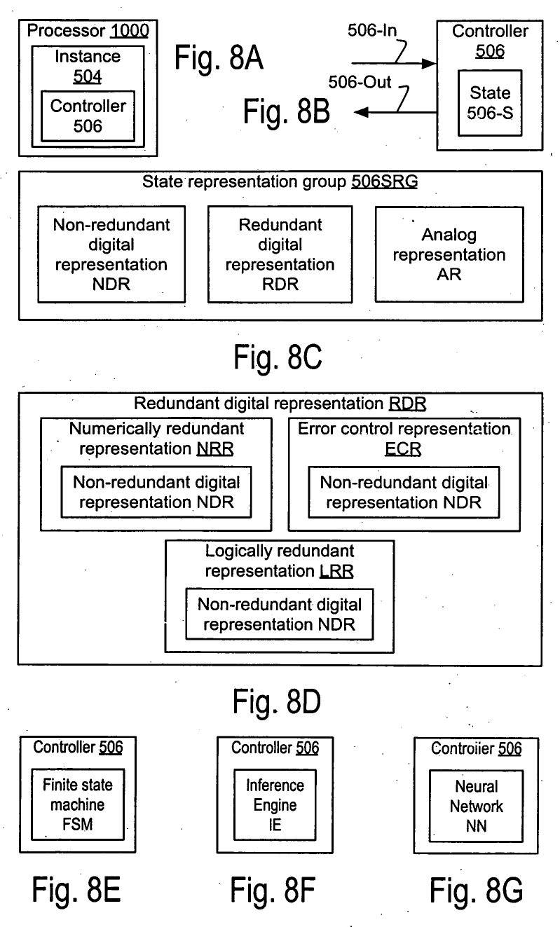

As used herein the processor 1000 may preferably include at least one instance 504 of a controller 506, as shown in FIG. 8A. As used herein, each controller receives at least one input 506 In, maintains and updates the value at least one state 506S and generates at least one output 506 Out based upon at least one of the inputs and/or the value of at least one of the states, as shown in FIG. 8B.

At least one state 506S may have a value including at least one member of the state representation group 506SRG consisting of the members: a non-redundant digital representation NDR and/or a redundant digital representation RDR and/or an analog representation AR, as shown in FIG. 8C. A non-redundant digital representation frequently comprises at least one digit, which may frequently represent a bit with values of 0 and 1, a byte including eight bits, and so on. Often non-redundant digital representations include representations of 16 bit integers, 32 bit integers, 16 bit floating point numbers, 32 bit floating point numbers, 64 bit floating point numbers, strings of bytes, fixed length buffers of bytes, integers, First-In-First-Out (FIFO) queues of such representations, and so on. Any, all and more than just these examples may be used as non-redundant digital representations of the state of a controller.

A redundant digital representation RDR of a non-redundant digital representation NDR may include a numerically redundant digital representation NRR, an error control representation ECR and/or a logically redundant representation LRR, as shown in FIG. 8D. The following examples Will serve to illustrate these redundant representations.

An example of a numerically redundant representation NRR may be found in a standard multiplier, which will often use a local carry propagate adder to add three or four numbers together to generate two numeric components which redundantly represent the numeric result of the addition.

An example of an error control representation ECR will frequently use the non-redundant digital representation and an additional component formed as the function of the non-redundant digital representation. If this error control representation is altered by a few number of bits, a error correcting function reconstructs the original non-redundant digital representation. Quantum computers are considered as controllers which will tend to use this kind of error control representations for at least some states.

An example of a logically redundant representation LRR may be found in the definition and implementation of many finite state machines, which often require that a single state be represented by any member of a multi-element set of non-redundant digital representation. Often the members of this set differ from at least one other member of the set by just one bit. Such logically redundant representations are often used to insure that the generation of glitches is minimized.

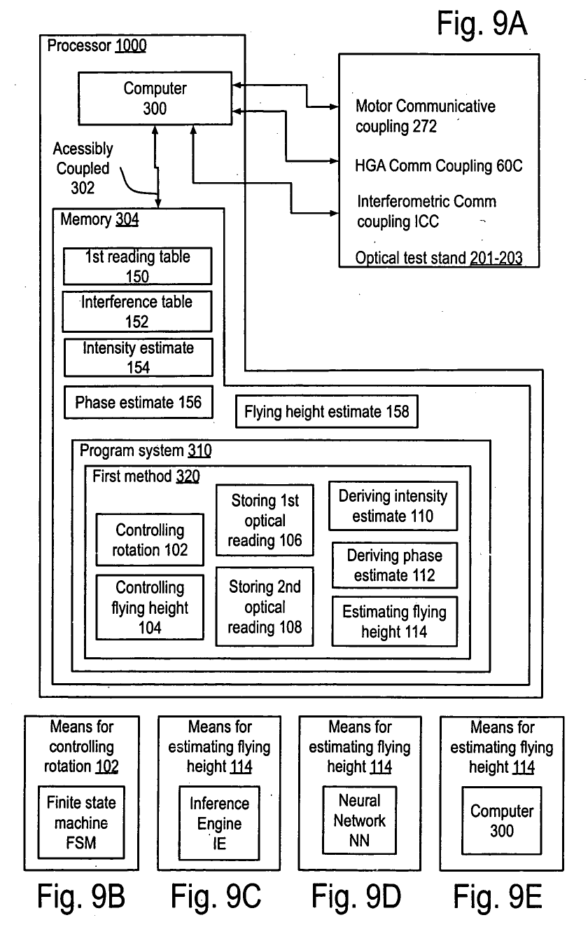

As used herein, the controller 506 may include an instance of a finite state machine FSM as shown in FIG. 8E, and/or include an instance of an inference engine IE as shown in FIG. 8F and/or an instance of a neural network NN as shown in FIG. 8G and/or an instance of a computer 300 directed by a program system 310 including program steps or operations residing in a memory 304 accessibly coupled 302 via a buss to the computer as shown in FIG. 9A. As used herein, a computer includes at least one instruction processor and at least one data processor, where each of the data processors is directed by at least one of the instruction processors.

The processor 1000 preferably acts as a control system 100 for the optical test stand 200 as shown in FIG. 7, and may include the following:
Means for controlling rotation 102 of the test disk 12T via the motor communicative coupling 272 to create the rotating disk surface 120-R at the rotational frequency RF.
Means for controlling flying height 104 of the slider 90 coupled to the head gimbal assembly 60 through the head gimbal assembly communicative coupling 60C.
Means for first storing 106 the first optical reading R1 in the first reading table 150 based upon the first reading time T1.
Means for second storing 108 the second optical reading R2 in the interference table 152 based upon the second reading time T2.
Means for first deriving 110 the intensity estimate 154 based upon the first reading table 150, the interference table 152 and the rotational frequency RF.
Means for second deriving 112 the phase estimate 156 based upon the first reading table 150, the interference table 152, and the rotational frequency RF.
And means for estimating 114 based upon the intensity estimate and the phase estimate to create an estimate of the flying height FH, which will also be referred to herein as the flying height estimate 158.

Measuring the first optical response BI and measuring the interference response B3 may occur concurrently in some embodiments, whereas in others, they may be measured sequentially.

At least one member of the means group may include at least one instance of a computer 300 accessibly coupled 302 to a memory 304 and at least partly directed by a program system 310 including at least one program step residing in the memory, as shown in FIG. 9E, a finite state machine as shown in FIG. 9B, an inference engine as shown in FIG. 9C, and a neural network as shown in FIG. 9D.

As used herein, the means group, consists of: means for controlling the rotation 102, the means for controlling 104 the flying height FH, the means for storing 106 the first optical reading R1, the means for storing 108 the second optical reading R2, the means for deriving 110 the intensity estimate 154, the means for deriving 112 the phase estimate 156, and the means for estimating flying height 114.

At least one member of the means group may include at least one instance of a computer 300 as shown in FIG. 9E accessibly coupled 302 to a memory 304 and at least partly directed by a program system 310 including at least one program step residing in the memory, a finite state machine FSM as shown in FIG. 9B, an inference engine IE as shown in FIG. 9C, and a neural network NN as shown in FIG. 9D.

As used herein, the means group, consists of: means for controlling rotation 102, as shown in FIG. 7, the means for controlling flying height 104, the means for first storing 106 the first optical reading R1, the means for second storing 108 the second optical reading R2, the means for first deriving 110 the intensity estimate 154, the means for second deriving 112 the phase estimate 156, and the means for estimating 114 the flying height estimate 158.

One skilled in the art will recognize that the first reading table 150 and the interference table 152 may be implemented as a single table. Alternatively, one or both may be implemented as linked lists. The units for intensity and phase may vary, for instance phase may be represented in degrees of arc. And the flying height may be represented in Angstroms.

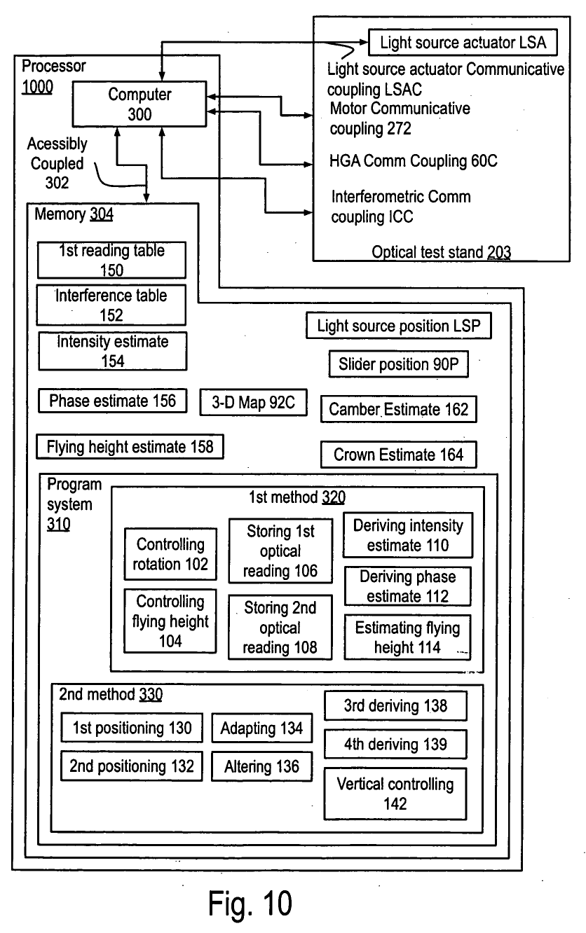

The program system 310 as shown in FIGS. 9A and 10 may at least partly implement the first method 320 by including the following program steps residing in the memory 304:
Controlling rotation 102 of the test disk 12T to create the rotating disk surface 120-R at the rotational frequency RF.
Controlling flying height 104 of the slider 90 coupled to the head gimbal assembly 60 via the head gimbal assembly communicative coupling 60C.
First storing 106 the first optical reading R1 in the first reading table 150 based upon the first reading time T1.
Second storing 108 the second optical reading R2 in the interference table 152 based upon the second reading time T2.
First deriving 110 the intensity estimate 154 based upon the first reading table, the interference table and the rotational frequency.
Second deriving 112 the phase estimate 156 based upon the first reading table, the interference table, and the rotational frequency.
And estimating 114 based upon the intensity estimate and the phase estimate to create the flying height estimate 158.

The program system 310 will be used to illustrate the second method 330 as shown in FIG. 10 preferably operating the third embodiment of the optical test stand 200 as shown in FIG. 3A, controlling the light source actuator LSA via the light source actuator communicative coupling LSAC to create the three-dimensional map 92C of the air bearing surface 92 of the slider 90, as follows:
First positioning 130 the slider 90 at a slider position 90P through the head gimbal assembly communicative coupling 60C.
Second positioning 132 the first light source LS1 at a first lighting position LSA-P through a light source actuator communicative coupling LSAC.
Using the first method 320 to create a flying height estimate 158 for the slider position and the first lighting position.
Adapting 134 the flying height estimate for the slider position and the first lighting position to at least partly create the three-dimensional map 92C of the air bearing surface 92 included in the slider 90.
Altering 136 at least one of the first slider position and/or the first lighting position and repeating the above steps to further create the three-dimensional map of the air bearing surface.

As before, the processor 1000 may preferably control the optical test stand 200 to at least partly implement the second method as follows:
The processor preferably directs the first positioning 130 of the slider 90 at a slider position 90P through the head gimbal assembly communicative coupling 60C. In certain further embodiments, the first positioning of the slider may include activating 140 a micro-actuator assembly 80 coupled to the slider to alter the slider position as shown in FIG. 3K.
The processor preferably directs the second positioning 132 of the first light source LS1 at a first lighting position LSA-P through the light source actuator LSA, in particular, through a light source actuator communicative coupling LSAC.
The processor may preferably use a version of the first method 320 to create the flying height estimate 158 for the slider position and the first lighting position.
The processor may preferably adapt 134 the flying height estimate for the slider position and the first lighting position to at least partly create the three-dimensional map 92C of the air bearing surface 92.
The processor may alter 136 at least one of the first slider position and/or the first lighting position and repeat the above steps to further create the three-dimensional map of the air bearing surface.

The processor 1000 may further include the following:
Means for first positioning 130 the slider at a slider position through the head gimbal assembly.
Means for second positioning 132 the first light source at a first lighting position through the light source actuator.
Means for using the first method 320 to create a flying height estimate for the slider position and the first lighting position.
Means for adapting 134 the flying height estimate for the slider position and the first lighting position to at least partly create the three-dimensional map of the air bearing surface.
Means for altering 136 at least one of the first slider position and/or the first lighting position and repeating the above steps to further create the three-dimensional map of the air bearing surface.

The second method 330 and its implementation as the program system 310 may further include at least one of the following:
Third deriving 138 a camber estimate 160 and/or a crown estimate 162 for the air bearing surface 92.
Vertical controlling 142 a vertical micro-actuator 98 included in the slider 90 to create an estimate of a vertical actuated deformation 97A of the slider while the vertical micro-actuator 98 is stimulated.

The processor 1000 may further implement the second method as follows:
The processor 1000 third deriving 138 the camber estimate 160 and/or the crown estimate 162 for the slider 90.
And/or the processor vertical controlling 142 the vertical micro-actuator 98 included in the slider to create the estimate of the vertical actuated deformation 97A of the slider while the vertical micro-actuator is stimulated.

The processor 1000 may further include at least one of the following:
Means for third deriving 132 the camber estimate 160 and/or the crown estimate 162 for the slider 90.
And/or means for vertical controlling 142 the vertical micro-actuator 98 included in the slider to create the estimate of the vertical actuated deformation 97A of the slider while the vertical micro-actuator is stimulated.

This second method can be used to create a touch-down estimate and/or a take-off estimate for a slider 90. As used herein, the touch-down estimate is an estimate the rotational rate for the test disk 12 at which the air bearing of the slider collapses, and the slider touches down on the rotating disk surface. Also, the take-off estimate is an estimate of the rotational rate at which the air bearing forms and becomes stable, which is when the slider takes off from the rotating disk surface. Both of these estimate rely altering the rotational rate and then creating the three-dimensional map 92C of the air bearing surface, because what portion of the slider is first or last to contact the disk surface 120-1 varies.

By extending the optical test stand 200 to control environmental conditions such as temperature, humidity and air pressure, the methods of this application can be employed to test the environmental effects of the performance of the slider 90 in its head gimbal assembly 60. In particular, it is possible to measure the effect of high temperature and humidity, which often leads to condensation across the air bearing and a drop in the flying height of the slider. Also, the effect of changing air pressure on the flying height of the slider can be estimated.

The preceding embodiments provide examples and are not meant to constrain the scope of the following claims.

What is claimed is:

1. An optical test stand, comprising:
a spin table include a first glass substrate coated with a protective layer topped by a layer of lubricant providing a rotating disk surface near which an air bearing surface of a slider is positioned by an actuator assembly;
said first glass substrate is compatible with a second glass substrate used in a disk of a two and one half inch hard disk drive;
said spin table is illuminated by a optical interferometer measuring an interference between a first light path and a second light path, both from a first light source;
said first light path includes a reflection off a test disk surface opposite said rotating disk surface; and
said second light path includes a reflection off said air bearing surface of said slider near said rotating disk surface.

2. The optical test stand of claim 1, wherein said first glass substrate provides said rotating disk surface with a first micro-waviness and said second glass substrate provides a second rotating disk surface with a second micro-waviness; wherein said second rotating disk surface is included in said disk in said hard disk drive;
wherein said first micro-waviness is within N percent of said second micro-waviness;
wherein said N is at most twenty.

3. The optical test stand of claim 2, wherein said N is at most ten.

4. The optical test stand of claim 1, wherein said spin table is further illuminated by a first light source emitting at least one output band only in a blue to ultra-violet color spectrum to originate said first light path and said second light path.

5. The optical test stand of claim 4, wherein said output band is composed of a monochromatic light output component.

6. The optical test stand of claim 4, wherein said output band is composed of a polychromatic light output component.

7. The optical test stand of claim 4, wherein said blue to ultra-violet color spectrum includes all electromagnetic radiation with a wavelength above 449 nanometers and below 501 nanometers.

8. The optical test stand of claim 4, wherein said first light source further emits at least two output bands in said blue to ultra-violet color spectrum.

9. The optical test stand of claim 1, wherein said optical interferometer uses a first light source positioned by a light source actuator to originate said first light path and said second light path.

10. The optical test stand of claim 9, wherein said light source actuator positions said first light source with at least one degree of motion-freedom.

11. The optical test stand of claim 9, wherein the motion of said first light source as positioned by said light source actuator is non-parallel to the motion of said air bearing surface of said slider as positioned by said actuator assembly.

12. The optical test stand of claim 11, wherein said motion of said first light source as positioned by said light source actuator in conjunction with said motion of said air bearing surface of said slider as positioned by said actuator assembly supports three dimensional contour mapping of said air bearing surface.

13. The optical test stand of claim 12, wherein said three dimensional contour mapping of said air bearing surface includes an estimate of the crown and of the camber of said air bearing surface.

14. The optical test stand of claim 12, wherein said slider includes a vertical micro-actuator stimulated by a vertical actuation control signal; and
wherein said three dimensional contour mapping of said-air bearing surface includes an estimate of a change in flying height of said read-write head of said slider when said vertical actuation control signal stimulates said vertical micro-actuator.
